(19) United States
(12) Patent Application Publication
(10) Pub. No.: US 2002/0194511 A1
(43) Pub. Date: Dec. 19, 2002

(54) Apparatus and method for central processing unit power measurement in a digital signal processor

(76) Inventor: Gary L. Swoboda, Sugar Land, TX (US)

Correspondence Address: TEXAS INSTRUMENTS INCORPORATED, P O BOX 655474, M/S 3999, DALLAS, TX, 75265

(21) Appl. No.: 09/920,193

(22) Filed: Aug. 1, 2001

Related U.S. Application Data
(60) Provisional application No. 60/299,023, filed on Jun. 18, 2001.
(60) Provisional application No. 60/299,016, filed on Jun. 18, 2001.

(51) Int. Cl. G06F 1/26

(52) U.S. Cl. 713/300

(57) ABSTRACT

In order to determine the power consumption of a program executed by the central processing unit of a digital signal processor, the power consumption associated with each of the component activities is determined. These power consumption values are stored and indexed by the associated activity. A program is then executed. The activities implementing the program are identified by trace signals and a trace unit, the trace unit analyzing the trace signals. The activities implementing the program are stored in a memory log. The activities stored in the log can then be used to reference the stored power consumption values. In this manner, the total power consumption for the program can be determined. The component power consumption values for activities resulting from the execution of the program can be used to improve the power efficiency of the digital signal processor.

This application claims the benefit of U.S. Provisional Application No. 60/299,023, filed Jun. 18, 2001; and U.S. Provisional Application No. 60/299,016, filed Jun. 18, 2001.

### RELATED U.S. PATENT APPLICATION

U.S. patent application ______ (Attorney Docket TI-33147), entitled APPARATUS AND METHOD FOR BUS POWER MEASUREMENT IN A DIGITAL SIGNAL PROCESSOR, invented by Gary L. Swoboda, filed on even date herewith, and assigned to the assignee of the present application is a related application.

### BACKGROUND OF THE INVENTION

1. Field of the Invention

This invention relates generally to digital signal processing units and, more particularly, to power consumption of digital signal processor units. The present invention provides apparatus and a technique for the measurement of the power consumed by the central processing unit of digital signal processing unit.

2. Background of the Invention

The digital signal processor and related devices have found increasing application in portable apparatus, such as cell phones, wireless internet devices, etc. The power consumption is a critical parameter for portable apparatus. The power consumption determines the size of the battery and the time between recharging the battery, key parameters in the portability and usefulness of the devices.

However, the power consumption parameter has several variables. The hardware implementing the device can, for example, be designed to run with minimum power expenditure. Even after every effort has been employed to reduce to power requirements of the implementing apparatus, the software programs being executed by the hardware may not be optimized with respect to power consumption. In addition, not only can the central processing unit draw power, but bus activity can also result in the consumption of power. However, before these parameters can be optimized, a technique for the measurement of the power consumption must be provided.

Recently, considerable effort has been expended in providing conducting leads from a terminal to selected portions of the central processing unit. These leads, typically referred to as trace leads or conductors, permit states and signals from selected portions of the central processing unit to be provided to external apparatus for analysis. The JTAG protocol is a specific example of a protocol that has been developed to provide standardized signals retrieved from the central processing unit. Based on the retrieved signals, the activity of the central processing unit can be determined. The JTAG protocol is relatively limited. However, more elaborate protocols along with expanded trace coupling within central processing unit are being developed to enhance to information concerning the operation of the central processing unit. The expanded protocols provide a more detailed examination of the internal operation of the central processing unit. The trace protocols have been particularly useful in the development and testing of complex digital signal devices. The expanded trace protocols have also found application in emulation and in hardware and software debug applications.

A need has therefore been felt for apparatus and an associated method having the feature that the power consumption in a digital signal processor unit can be measured. It would be a feature of the apparatus and associated method to measure the power consumed by the central processing unit during an execution of a program. It would be yet another feature of the apparatus and associated method to provide power consumption information with respect to execution of the activities comprising a program being executed by the central processing unit. It would be a more particular feature of the apparatus and associated method to identify the activities implementing a program being executed by a central processing unit and to associate the power consumed with each activity. It would be yet a further feature of the apparatus and associated method to determine the total power consumed by central processing unit during the execution of a program as well as to determine the power consumed by the individual activities of which the program is comprised.

### SUMMARY OF THE INVENTION

The aforementioned and other features are accomplished, according to the present invention, by providing the central processing unit with a multiplicity of trace connections, the trace connections being coupled to selected portions of the central processing system. The signals applied to the trace connections by the central processing unit can be analyzed by a trace unit to determine the activity currently being implemented by the central processing unit. The activity identified by the trace unit is stored in a first memory portion as a log of activity. The amount of power consumed by each activity, indexed by activity, is stored in a second memory portion (or unit). The amount of energy consumed for each activity is determined by a simulation of that activity, or by some other method. The activities comprising the program are retrieved from the first memory portion and are used to retrieve the power consumption for each activity. The total power consumption by the central processing unit for the program can then be determined. In addition, the contribution to the total power consumption from each activity can be reviewed to optimize the program.

### BRIEF DESCRIPTION OF THE DRAWINGS

FIG. 1 is a block diagram of the apparatus for determining power consumed by a central processing unit of a digital signal processor in the execution of program according to the present invention.

FIG. 2 is flow chart illustrating the process for determining the power consumed by a central processing unit of a digital signal processor during the execution of a program according to the present invention.

### DESCRIPTION OF THE PREFERRED EMBODIMENT

1. Detailed Description of the Drawings

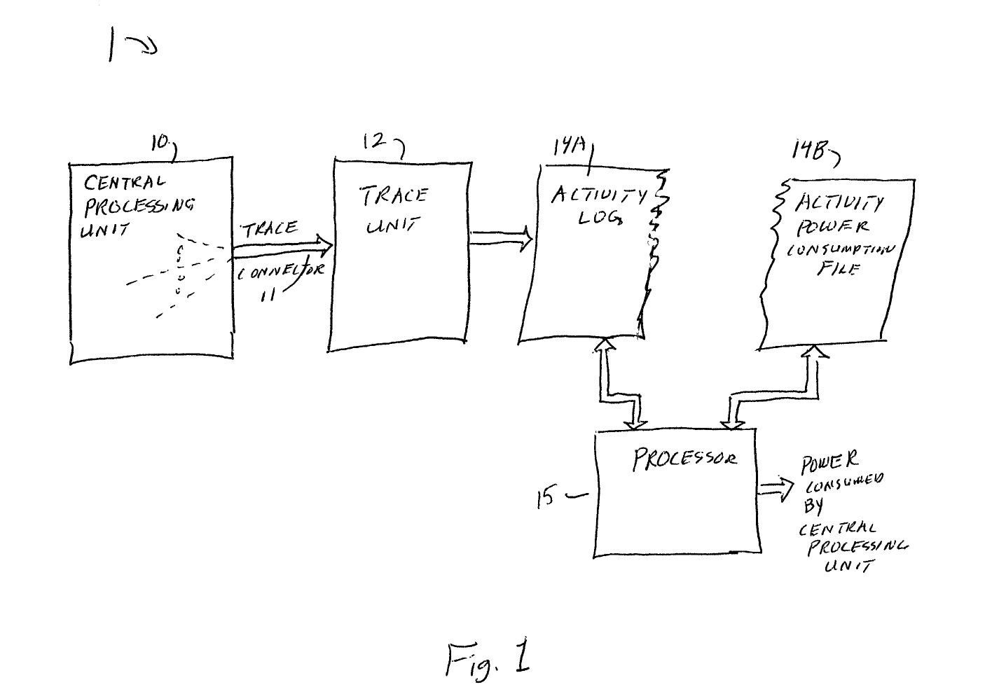

Referring to FIG. 1, a central processing unit 10 has trace leads coupled to selected pathways in the central processing unit 10. The trace leads permit the activity of the selected pathways of the central processing unit 10 to be monitored. The trace leads are coupled to a trace conductor 11. The trace conductor 11 applies the signals collected in the central processing unit 10 to a trace unit 12. The trace unit 12 analyzes the signals transferred by the trace conductor 11. As a result of this analysis, the activity that results in the signals transferred by the trace conductor 11 can be determined. This activity is then stored in an activity log a first portion 14A of a memory unit. An activity power consumption file is stored in a second portion 14B of the same or a different memory unit. The activity power consumption file 14B provides a power consumption value indexed by activity. These power consumption values are determined by simulation of the activity or by some other technique. A processor 15 retrieves the activity identifiers from the activity log 14A. The processor then retrieves the power consumption value associated for each activity identifier from the activity power consumption file 14B. The processor then sums all of power consumption values for the programs/activities occurring within a selected window. The result of this summation is the power consumption for the central processing unit 10 for a selected window of activity.

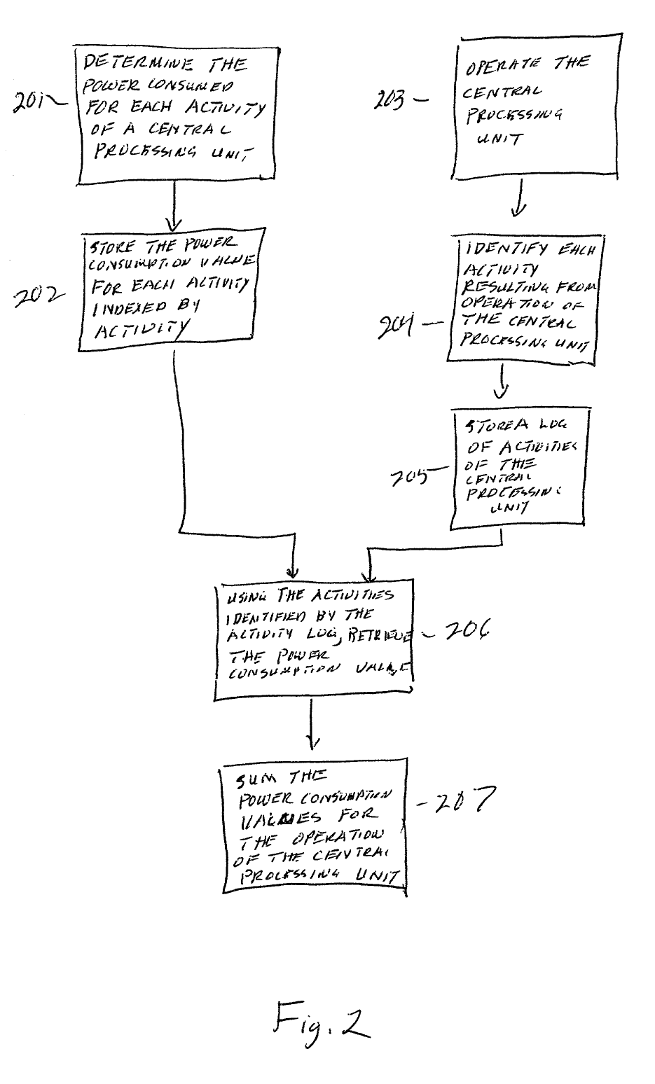

Referring to FIG. 2, the process for determining the power consumed by the central processing unit of a digital signal processor is shown. In step 201, the power consumption by the central processing unit is determined for each activity of the central processing unit. This determination can be performed by simulation techniques or by other techniques. The power consumption for each activity is stored in a second memory portion indexed by the activity in step 202. That is, knowing the activity, the related power consumption value can be retrieved from this second memory portion. In step 203, the central processing unit performs a predetermined operation or series of operations. During the operation of the central processing unit, the component activities used by the central processing unit to implement the operation are identified in step 204. This identification is provided by the trace signals applied to, and analyzed by, a trace unit. In step 205, the identified activity is stored in an activity log in a first memory portion. In step 206, the activities identified in the activity log are retrieved from the first memory portion and these activities are used to access the power consumption values in the second memory portion. In step 207, the power consumption values retrieved from the second memory portion can be added to the previously retrieved values to provide, once all the entries from the activity log have been retrieved and the associated power consumption values retrieved, the total power consumed by the central processing unit during its operation. The operation of the central processing unit can result from program, a portion of a program, or a sequence of programs.

2. Operation of the Preferred Embodiment

The foregoing procedure can be used to determine the power consumption required to execute a program. The trace signals and the trace unit identify the component activity of the central processing unit during execution of a program. This central processing unit configuration is present in many of the digital signal processors under development. The capabilities of the trace signal and trace unit used in the present procedure are therefore typically available although for different purposes. The component activity is used to determine the associated power consumption for each activity. Consequently, the power consumed by the central processing unit can be determined for the program by summing the power consumption for individual activities. In addition, the ability to associate the power consumption with the component activities permits a more detailed review of the power required by the central processing unit to execute the program. Through the analysis of the central processing unit activity and the component activity power consumption, the program can be refined to be more power efficient.

While the invention has been described with respect to the embodiments set forth above, the invention is not necessarily limited to these embodiments. Accordingly, other embodiments, variations, and improvements not described herein are not necessarily excluded from the scope of the invention, the scope of the invention being defined by the following claims.

What is claimed is:

1. Apparatus for measuring the power consumption of a central processing unit in a digital signal processor, the apparatus comprising:
a plurality of trace leads coupled to selected portions of the central processing unit;
a trace unit coupled to the trace leads; the trace unit analyzing signals from the central processing unit to determine the current activity of the central processing unit;
a first memory portion for storing a log of activities resulting from operation of the central processing unit;
a second memory portion storing power consumption values for each activity, the power consumption values being indexed by activity; and
a processor for retrieving the activities forming the log in the first memory portion, the processor retrieving power consumption values from the second memory portion for activities retrieved from the log.

2. The apparatus as recited in claim 1 wherein the activity log is a sequence of activities implementing execution of a program.

3. The apparatus as recited in claim 2 wherein the processor sums the power consumption values retrieved from the second memory portion.

4. The apparatus as recited in claim 1 wherein the power consumption values associated with each activity is determined by simulation of the activity.

5. The apparatus as recited in claim 2 wherein the activity log and the power consumption values are used to optimize a program.

6. The method of measuring the power consumed by a central processing unit, the method comprising: determining the power consumption value for each activity in the central processing unit;
storing the power consumption for each activity in a second memory file using the central processing unit activity as an index;
during the operation of the central processing unit, using a trace unit to identify the activity being implemented in the central processing unit;
storing the central processing unit activities identified by the trace unit to form an activity log; and
using the activities of the activity log, retrieving the power consumption values for each activity of the activity log;

7. The method as recited in claim 6 wherein the storing step includes the step of forming an activity log for a program.

8. The method as recited in claim 7 further comprising the step of adding the power consumption values for all the activities of the activity log to provide a total power consumption for the program.

9. The method as recited in claim 6 wherein the power consumption values are obtained by simulation techniques.

10. The method as recited in claim 7 wherein the activity log and the file of power consumption values are used to optimize the program.

11. A system for testing a power consumption of a digital signal processor central processing unit, the central processing unit having trace leads coupled to preselected portions of the central processing unit, the system comprising:
a trace unit coupled to the central processing unit trace leads, the trace unit identifying central processing unit activity from the signals applied to the trace leads by the central processing unit;
a first memory portion coupled to the trace unit, the first memory portion storing an activity log of the activities of the central processing unit;
a second memory portion, the second memory portion storing power consumption values indexed for each activity; and
a processor coupled to the first memory portion and the second memory portion, the processor retrieving the activities of the activity log and using each retrieved activity to retrieve the power consumption value for the activity.

12. The system as recited in claim 11 wherein the activity log is a sequence of activities for a program.

13. The system as recited 12 wherein the processor sums all of the power consumption values for the activity log to provide the total power consumed by the program.

14. The system as recited in claim 11 wherein the power consumption values are derived by simulation techniques.
